(19) United States
(12) Patent Application Publication
(10) Pub. No.: US 2025/0174763 A1
(43) Pub. Date: May 29, 2025

(54) POWER STORAGE DEVICE MODULE

(71) Applicant: Prime Planet Energy & Solutions, Inc., Tokyo (JP)

(72) Inventors: Satoshi FUJIMURA, Toki-shi (JP); Hiroki TAKAHASHI, Toyota-shi (JP)

(21) Appl. No.: 18/916,705

(22) Filed: Oct. 16, 2024

(30) Foreign Application Priority Data
Nov. 29, 2023 (JP) 2023-201962

(51) Int. Cl. H01M 10/6566; H01G 11/78; H01M 10/613; H01M 10/625; H01M 50/119; H01M 50/209; H01M 50/291

(52) U.S. Cl. CPC H01M 10/6566; H01M 10/613; H01M 10/625; H01M 50/119; H01M 50/209; H01M 50/291; H01G 11/78

(57) ABSTRACT

A power storage device module includes a plurality of power storage devices arranged in a row, and an intervening member interposed between adjacent ones of the power storage devices. Each of the power storage devices includes an electrode body and a metal case that houses the electrode body. A case outer surface of the case includes a contact part, which contacts with the intervening member. This contact part includes a tip abutting part having numerous protrusions, whose tips abut on the intervening member with the intervening member with a reduced contact area.

### CROSS-REFERENCE TO RELATED APPLICATIONS

This application is based upon and claims the benefit of priority to Japanese Patent Application No. 2023-201962 filed on Nov. 29, 2023, the entire contents of which are incorporated herein by reference.

### BACKGROUND

### Technical Field

The disclosure relates to a power storage device module in which a plurality of power storage devices is arranged in a row with intervening members each interposed between adjacent ones of the power storage devices.

### Related Art

Conventionally, a battery module in which a plurality of batteries is arranged in a row with intervening members made of resin or other materials has been known. One example of the related art is disclosed in Japanese unexamined patent application publication No. 2018-032581 (JP 2018-032581A).

### SUMMARY

### Technical Problems

In this battery module, when any one of the batteries generates heat, the heat of this battery is transferred to the batteries located adjacent to the one battery via the intervening members, and the temperatures of the adjacent batteries also rise.

The present disclosure has been made to address the above problems and has a purpose to provide a power storage device module capable of reducing heat conduction from a case of a power storage device to intervening members located on both sides of the power storage device and suppress heat transfer to adjacent power storage devices through the intervening members.

### Means of Solving the Problems

(1) To achieve the above-mentioned purpose, one aspect of the present disclosure provides a power storage device module comprising: a plurality of power storage devices arranged in a row; and an intervening member interposed between adjacent ones of the power storage devices, each of the power storage devices including an electrode body and a case that is made of metal and houses the electrode body, the case having a case outer surface exposed to outside, the case outer surface including a contact part that contacts with the intervening member, wherein the contact part of the case outer surface includes: a tip abutting part including numerous protrusions having tips that contact with the intervening member with a smaller contact area than when a tip abutting part is flat without protrusions.

In the above-described power storage device module, the contact part of the case outer surface of each of the power storage devices includes the tip abutting part whose contact area with the intervening member is reduced by the numerous protrusions, that is, the tip abutting part having a smaller contact area with the intervening member than the contact area if the tip abutting part were flat without protrusions, i.e., than the plane area of this flat tip abutting part. The contact part of each power storage device and the intervening member are placed in contact with each other over a small surface area. Thus, the heat conduction from the contact part of each power storage device to the intervening member is reduced as compared with when the contact part of each power storage device does not have the above-mentioned tip abutting part. This can suppress the heat generated in one of the power storage devices from being transferred to an adjacent power storage device through the intervening member, which can prevent a temperature rise of the adjacent power storage device.

The “power storage device” may include, for example, secondary batteries, such as lithium-ion secondary batteries, sodium-ion secondary batteries, calcium-ion secondary batteries, and capacitors, such as lithium-ion capacitors.

The “tip abutting part” may be formed for example by the following methods. Specifically, the tip abutting part with numerous protrusions may be formed by subjecting the contact part of the case outer surface to a physical surface roughening treatment, such as shot blasting, sand blasting, or metal spraying, a chemical surface roughening treatment, such as anodic oxidation or chemical etching, or a surface roughening treatment that forms nano-order protrusions by irradiation of pulsed laser. Alternatively, the tip abutting part with numerous protrusions may be formed by pressing.

Further, the tip abutting part may also be formed in only a part of the contact part of the case outer surface or alternatively formed in the entirety of the contact part. Moreover, numerous protrusions similar to the numerous protrusions of the tip abutting part may be formed in other portions of the case outer surface than the contact part.

The “intervening member” may include for example an intervening member made of resin and an intervening member made of metal. The intervening member may also be an intervening member made of elastic material, such as rubber or elastomer, and designed to be hard enough to suppress a contact portion of the intervening member that contacts with tip abutting part from becoming deformed, e.g., dented, to cover or surround the tips (i.e., apex portions) of the protrusions of the tip abutting part when the protrusions abut on the intervening member and to avoid an increase in the contact area with the protrusions. The number of the intervening members placed between adjacent ones of the power storage devices may be single or multiple.

The form of the intervening member may include an intervening member having a plate-like shape as a whole, and an intervening member including an intervening main body that has a plate-like shape and an intervening protruding portion that protrudes from the intervening main body to the contact part of the power storage device and contact with contact part, for example. In the latter intervening member, because of the presence of the intervening protruding portion between the intervening main body and the power storage device, a cooling channel for flowing a cooling medium, such as cooling air, can be provided between the intervening main body and the power storage device.

(2) In the power storage device module described in (1), the numerous protrusions may be provided on only the contact part of the case outer surface.

In the above-described power storage device module, any part of the case outer surface other than the contact part does not need to be provided with numerous protrusions. This configuration can achieve a low-cost power storage device and hence a low-cost power storage device module while ensuring sufficient heat insulation for the intervening member.

(3) The power storage device module described in (1) may also be configured such that the intervening member includes: an intervening main body placed between adjacent ones of the power storage devices; and an intervening protruding portion protruding from the intervening main body to the contact part of at least one of the adjacent power storage devices and contacting the contact part, the case outer surface of each of the power storage devices includes, in addition to the contact part, a spaced facing part that faces the intervening main body and is spaced apart from the intervening main body, forming a cooling channel between the spaced facing part and the intervening main body, and the spaced facing part includes the numerous protrusions that provide a larger surface area that borders the cooling channel than when a spaced facing part is flat without the protrusions.

In the above-described power storage device module, the cooling channel for flowing the cooling medium, such as cooling air, is also formed between the intervening main body of the intervening member and the spaced facing part of the case outer surface of each of the power storage devices, and numerous protrusions are also formed in the spaced facing part. The numerous protrusions provided in this spaced facing part are similar in form to the numerous protrusions of the contact part but are different in function. Specifically, the numerous protrusions of the spaced facing part increase the surface area bordering the cooling channel, that is, the surface area of the spaced facing part, than the surface area of the spaced facing part if it were flat without protrusions, i.e., than the plane area of the spaced facing part, and thus can efficiently release the heat of the power storage device through the spaced facing part. In the foregoing power storage device module, therefore, the contact part of the case outer surface can suppress the heat of the power storage device from transferring to an adjacent power storage device, that is, can insulate the heat of the power storage device, while allowing the spaced facing part to efficiently release the heat of the power storage device.

Further, numerous protrusions of the contact part and numerous protrusions of the spaced facing part are similar in form. This is advantageous because the protrusions can be formed simultaneously by the same method when forming numerous protrusions on the case outer surface.

### BRIEF DESCRIPTION OF THE DRAWINGS

FIG. 1 is a perspective view of a battery constituting a battery module in a first embodiment;

FIG. 2 is a side view of the battery seen from a first wide side surface side in the first embodiment;

FIG. 3 is a side view of the battery seen from a second wide side surface side in the first embodiment;

FIG. 4 is a partial cross-sectional view of the battery module, taken in a top-bottom direction and an arrangement direction of the battery module in the first embodiment;

FIG. 5 is an enlarged partial cross-sectional view of a part A in FIG. 4 in the battery module in the first embodiment;

FIG. 6 is a partial cross-sectional view of a battery module, taken in a top-bottom direction and an arrangement direction of a battery module in a second embodiment;

FIG. 7 is an enlarged partial cross-sectional view of a part B in FIG. 6 in the battery module in the second embodiment; and

FIG. 8 is a partial cross-sectional view of a battery module, taken in a top-bottom direction and an arrangement direction of the battery module in a third embodiment.

### DETAILED DESCRIPTION OF THE EXEMPLARY EMBODIMENTS

### First Embodiment

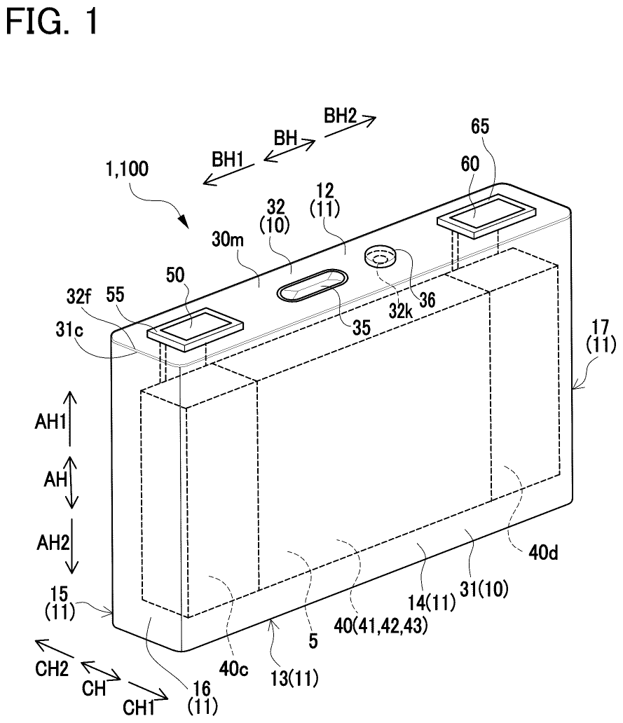

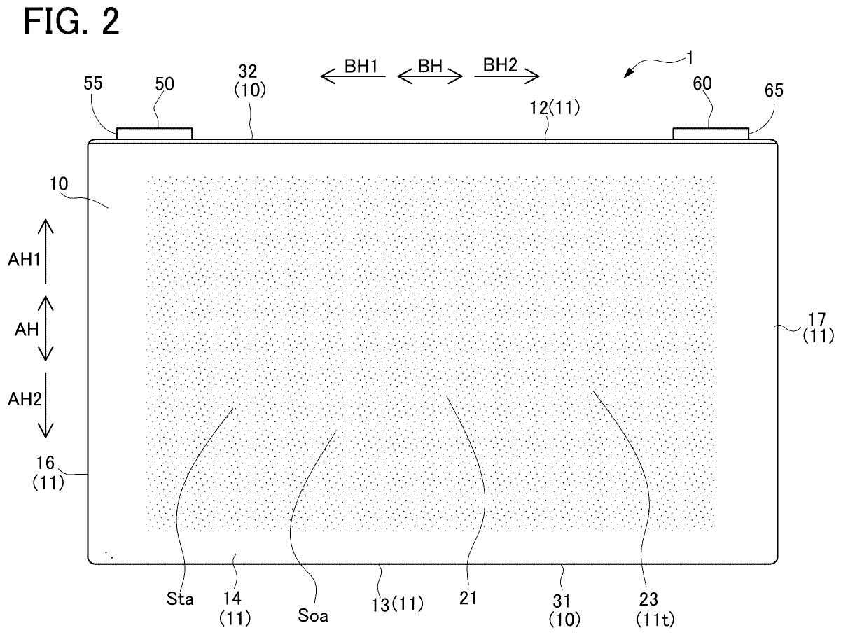

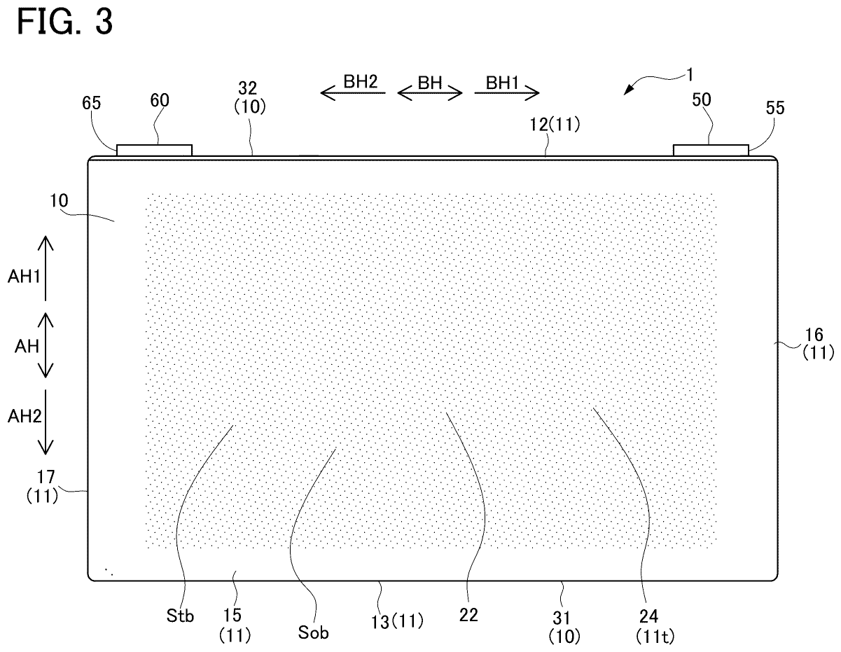

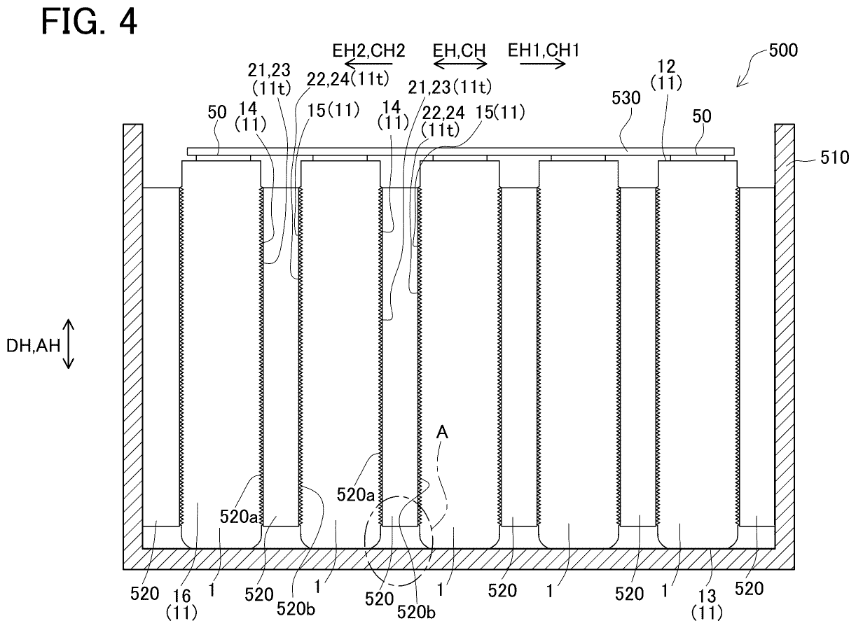

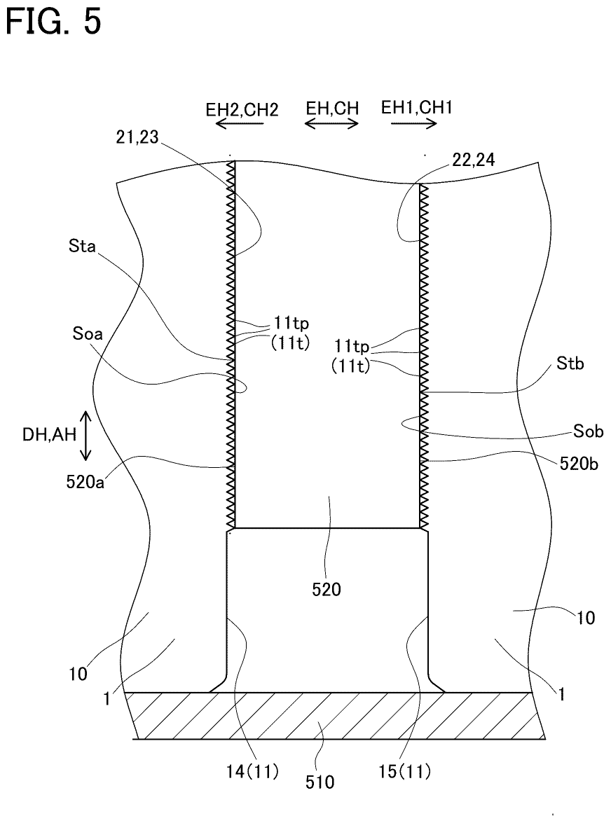

A detailed description of a first embodiment of this disclosure will now be given referring to the accompanying drawings. FIG. 1 is a perspective view of a battery (one example of a power storage device of the disclosure) 1 constituting a battery module (one example of a power storage device module of the disclosure) 500. FIG. 2 is a side view of the battery 1 seen from a first wide side surface 14 side, and FIG. 3 is a side view of the battery 1 seen from a second wide side surface 15 side. Further, FIG. 4 is a partial cross-sectional view of a battery module 500 and further FIG. 5 is an enlarged partial cross-sectional view of a part A of the battery module 500 shown in FIG. 4. The following description will be given under the definitions that the battery height direction AH, battery width direction BH, and battery thickness direction CH of the battery 1 are the directions indicated by arrows in FIG. 1 to FIG. 3, and the top-bottom direction DH and arrangement direction EH of the battery module 500 are the directions indicated by arrows in FIG. 4 and FIG. 5.

The battery module 500 will be mounted in vehicles, such as hybrid cars, plug-in hybrid cars, and electric cars. The battery module 500 includes a plurality of batteries 1. Each of the batteries 1 is a sealed lithium ion secondary battery having a prismatic shape, i.e., a rectangular parallelepiped box-like shape, and composed of a case 10, an electrode body 40 and an electrolyte 5 housed in the case 10, a positive terminal 50 and a negative terminal 60 supported in the case 10, and others (see FIGS. 1 to 3).

The case 10 is made of metal (aluminum in the present embodiment) and formed in a rectangular parallelepiped box-like shape, and composed of a case body 31 and a case lid 32. The case body 31 has a bottomed rectangular prismatic shape with a rectangular opening portion 31c, in which the electrode body 40 is housed. The case lid 32 has a rectangular plate-like shape and closes the opening portion 31c of the case body 31. The opening portion 31c of the case body 31 and a peripheral portion 32f of the case lid 32 are hermetically welded together over their entire circumference. The case lid 32 is provided with a safety valve 35, which can break open when the internal pressure of the case 10 exceeds a valve opening pressure. The case lid 32 is further provided with a liquid inlet 32k, which is hermetically sealed with a sealing member 36 made of aluminum in a circular disk shape.

The case lid 32 is further provided with rectangular through holes, not shown, respectively located near an end on the one side BH1 and near an end on the other side BH2 in the battery width direction BH. In the through hole on the one side BH1, the positive terminal 50 made of aluminum is inserted, and fixed to the case lid 32 while being insulated from the case lid 32 via a resin member 55. The positive terminal 50 is welded, at its distal end portion on the lower side AH2 in the battery height direction AH, to a positive current collector part 40c, mentioned later, of the electrode body 40 inside the case 10 and thus conductively connected to the positive current collector part 40c. In the through hole on the other side BH2, the negative terminal 60 made of copper is inserted, and fixed to the case lid 32 while being insulated from the case lid 32 via a resin member 65. The negative terminal 60 is welded, at its distal end portion on the lower side AH2 in the battery height direction AH, to a negative current collector part 40d, mentioned later, of the electrode body 40 inside the case 10 and thus conductively connected to the negative current collector part 40d.

The electrode body 40 is a rectangular parallelepiped, stacked electrode body, in which a plurality of rectangular positive electrode plates 41 and a plurality of rectangular negative electrode plates 42 are alternately stacked in the battery thickness direction CH with rectangular separators 43 each made of porous resin film interposed therebetween. In the electrode body 40, on the one side BH1 in the battery width direction BH, the positive current collector part 40c is formed of current collecting foils of the positive electrode plates 41, superimposed in the battery thickness direction CH. This positive current collector part 40c is conductively connected to the positive terminal 50. Further, in the electrode body 40, on the other side BH2 in the battery width direction BH, the negative current collector part 40d is formed of current collecting foils of the negative electrode plates 42, superimposed in the battery thickness direction CH. This negative current collector part 40d is conductively connected to the negative terminal 60.

Next, a case outer surface 11 of the case 10, exposed to the outside of the case 10, that is, facing outward, will be described in detail, referring to FIG. 1 to FIG. 3. The case 10 has a rectangular parallelepiped box-like shape. The case outer surface 11 has an upper surface 12, lower surface 13, first wide side surface 14, second wide side surface 15, first narrow side surface 16, and second narrow side surface 17, each having a rectangular shape. The upper surface 12 is located on the upper side AH1 and the lower surface 13 is located on the lower side AH2. The first wide side surface 14 and the second wide side surface 15 each have a larger area than each of the first narrow side surface 16 and the second narrow side surface 17. The first wide side surface 14 is located on the one side CH1 in the battery thickness direction CH and the second wide side surface 15 is located on the other side CH2 in the battery thickness direction CH. The first narrow side surface 16 is located on the one side BH1 in the battery width direction BH and the second narrow side surface 17 is located on the other side BH2 in the battery width direction BH.

The case outer surface 11 includes a first contact part 21 (hereinafter, also referred simply to as a “contact part”) and a second contact part 22 (hereinafter, also referred simply to as a “contact part”), which contact with intervening members 520 mentioned later (see FIG. 4 and FIG. 5).

The first contact part 21 is a rectangular central portion as part of the first wide side surface 14 of the case outer surface 11, except for a peripheral portion (see FIG. 2). This first contact part 21 includes a first tip abutting part (hereinafter, also referred simply to as an “tip abutting part”) 23 formed with numerous protrusions 11t (indicated by dots in FIG. 2). Specifically, in the first embodiment, the entirety of the first contact part 21 corresponds to the first tip abutting part 23. The numerous protrusions 11t of the first tip abutting part 23 abut on the intervening member 520 at only their tips (i.e., apex portions) 11tp, as described later (see FIG. 5), and thus the contact area Sta between the first tip abutting part 23 and the intervening member 520 is reduced, i.e., is smaller, than that in a configuration not formed with the numerous protrusions 11t.

In the first embodiment, the first tip abutting part 23 including the numerous protrusions 11t and the second tip abutting part 24 including numerous protrusions 11t mentioned later are formed by metal spraying, but may be formed by a physical or chemical surface roughening treatment, or a surface roughening treatment that forms nano-order protrusions by irradiation of pulsed laser beams.

The second contact part 22 is a rectangular central portion as part of the second wide side surface 15 of the case outer surface 11, except for a peripheral portion (see FIG. 3). This second contact part 22 also includes a second tip abutting part (hereinafter, also referred simply to as an “tip abutting part”) 24 formed with numerous protrusions 11t (indicated by dots in FIG. 3), as with the first tip abutting part 23 of the first contact part 21. The numerous protrusions 11t of the second tip abutting part 24 abut on the intervening member 520 at only their tips 11tp, as described later (see FIG. 5), and thus the contact area Stb between the second tip abutting part 24 and the intervening member 520 is reduced, i.e., is smaller, than that in a configuration not formed with the numerous protrusions 11t.

In the first embodiment, the numerous protrusions 11t are provided on only the first contact part 21 and the second contact part 22 of the case outer surface 11. In other words, the numerous protrusions 11t do not exist on the upper surface 12, the lower surface 13, the peripheral portion of the first wide side surface 14, the peripheral portion of the second wide side surface 15, the first narrow side surface 16, and second narrow side surface 17.

Next, the battery module 500 provided with a plurality of the batteries 1 will be described below, referring to FIG. 4 and FIG. 5. The battery module 500 includes the plurality of batteries 1 arranged in a row in the arrangement direction EH assuming that the battery height direction AH coincides with the top-bottom direction DH of the battery module 500, and the battery thickness direction CH coincides with the arrangement direction EH, a plurality of intervening members 520 each arranged between adjacent ones of the batteries 1 in the arrangement direction EH, and a module case 510 that accommodates the batteries 1 and the intervening members 520.

The module case 510 is made of resin and formed in a bottomed rectangular prismatic shape having a rectangular opening. This module case 510 restrains the batteries 1 and the intervening members 520 in the arrangement direction EH, which are arranged in a row in the arrangement direction EH. Each of the batteries 1 housed in the module case 510 is oriented so that the one side CH1 in the battery thickness direction CH coincides with the one side EH1 (the right side in FIG. 4 and FIG. 5) in the arrangement direction EH, that is, the first wide side surface 14 is positioned on the one side EH1 in the arrangement direction EH, while the other side CH2 in the battery thickness direction CH coincides with the other side EH2 (the left side in FIG. 4 and FIG. 5) in the arrangement direction EH, that is, the second wide side surface 15 is positioned on the other side EH2 in the arrangement direction EH. The positive terminals 50 of adjacent batteries 1 are electrically connected to each other and the negative terminals 60 of the adjacent batteries 1 are electrically connected to each other, respectively via busbars (electrically-conductive connection members) 530, so that the batteries 1 constituting the battery module 500 are connected in parallel to each other. Each busbar 530 has a rectangular plate-like shape and is weld-bonded to the positive terminals 50 or the negative terminals 60.

Next, the intervening members 520 will be described. The intervening members 520 are each disposed between adjacent ones of the batteries 1 and further between the module case 510 and each endmost one of the batteries 1 in the arrangement direction EH. Each of the intervening members 520 is made of insulation elastic material, e.g., ethylene propylene diene rubber (EPDM) in the present embodiment, formed in a rectangular plate-like shape, and includes a first main surface 520a and a second main surface 520b, each of which is entirely flat, and smaller in area than the first wide side surface 14 and the second wide side surface 15 of each battery 1. Further, the intervening members 520 are each placed in such an orientation that the first main surface 520a is located on the other side EH2 in the arrangement direction EH and the second main surface 520b is located on the one side EH1 in the arrangement direction EH.

The first main surface 520a of the intervening member 520 is in contact with the first contact part 21 (the first tip abutting part 23) of the first wide side surface 14 as part of the case outer surface 11 of the battery 1 located on the other side EH2 in the arrangement direction EH of the intervening members 520. In other words, the first contact part 21 of the battery 1 and the first main surface 520a of the intervening member 520 contact each other by the numerous protrusions 11t provided in the first tip abutting part 23 of the battery 1 abutting, at their tips 11tp, on the first main surface 520a of the intervening member 520. The contact area Sta between the first tip abutting part 23 of the battery 1 and the first main surface 520a of the intervening member 520 is smaller than the contact area of the first tip abutting part 23 if it were flat without the protrusions 11t, i.e., than the plane area Soa of the first tip abutting part 23 (Sta<Soa). To be specific, the contact area Sta between the first tip abutting part 23 and the first main surface 520a is approximately one-tenth of the plane area Soa of the first tip abutting part 23. Thus, the heat conduction from the first contact part 21 of the first wide side surface 14 of the battery 1 to the first main surface 520a of the intervening member 520 is low.

Further, the second main surface 520b of the intervening member 520 is in contact with the second contact part 22 (the second tip abutting part 24) of the second wide side surface 15 as part of the case outer surface 11 of the battery 1 located on the one side EH1 in the arrangement direction EH of the intervening members 520. In other words, the second contact part 22 of the battery 1 and the second main surface 520b of the intervening member 520 contact each other by the numerous protrusions 11t provided in the second tip abutting part 24 of the battery 1 abutting, at their tips 11tp, on the second main surface 520b of the intervening member 520. The contact area Stb between the second tip abutting part 24 of the battery 1 and the second main surface 520b of the intervening member 520 is smaller than the contact area of the second tip abutting part 24 if it were flat without the protrusions 11t, i.e., than the plane area Sob of this second tip abutting part 24 (Stb<Sob). To be specific, the contact area Stb between the second tip abutting part 24 and the second main surface 520b is approximately one-tenth of the plane area Sob of the second tip abutting part 24. Thus, the heat conduction from the second contact part 22 of the second wide side surface 15 of the battery 1 to the second main surface 520b of the intervening member 520 is low.

In the battery module 500 of the first embodiment, the contact parts 21 and 22 of the case outer surface 11 of each battery 1 respectively include the tip abutting parts 23 and 24 whose contact area Sta or Stb with the intervening member 520 is reduced by the numerous protrusions 11t, so that each of the contact parts 21 and 22 of the battery 1 contacts, over a small area, with one of the intervening members 520 located on both sides of the battery 1. This configuration can reduce the heat conduction from the contact parts 21 and 22 of the battery 1 to the intervening members 520 as compared with a configuration where the contact parts 21 and 22 of the battery 1 do not include the tip abutting parts 23 and 24. Thus, even when one battery 1 in the battery module 500 generates heat, this heat is suppressed from transferring to adjacent batteries 1 via the intervening members 520, and hence suppress a temperature rise of the adjacent batteries 1.

In the first embodiment, furthermore, only the contact parts 21 and 22 of the case outer surface 11 of each battery 1 are provided with the numerous protrusions 11t. Therefore, other portions of the case outer surface 11 than the contact parts 21 and 22 do not need to be provided with the numerous protrusions 11t. This configuration can achieve a low-cost battery 1 and a low-cost battery module 500 while ensuring sufficient heat insulation with respect to the intervening members 520.

### Second Embodiment

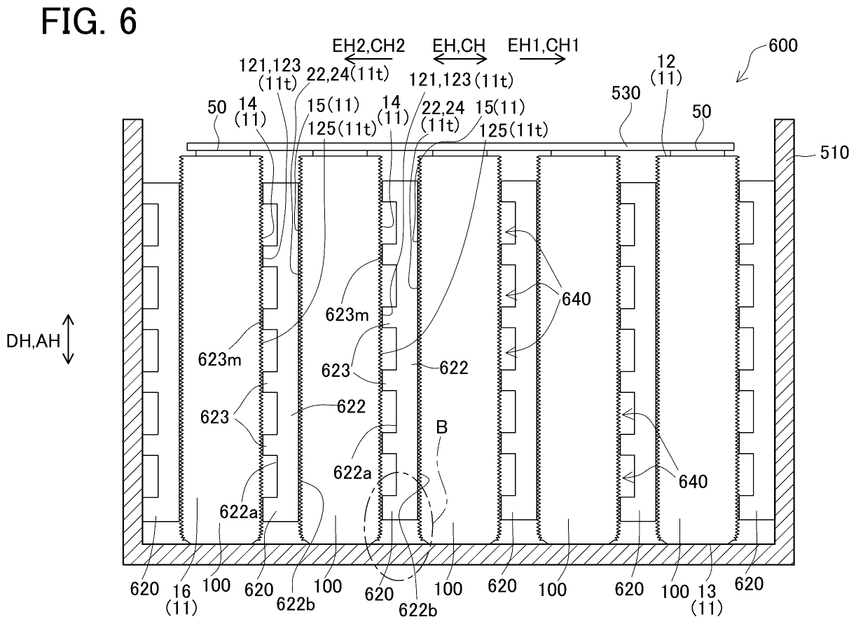

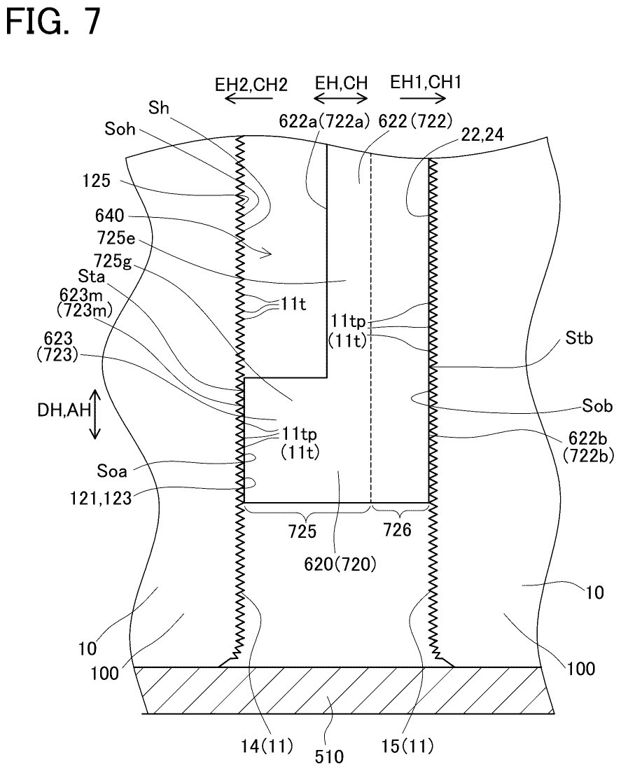

Next, a second embodiment will be described, referring to FIG. 6 and FIG. 7. In the following description, similar or identical parts to those of the first embodiment are omitted or briefly described. For the battery module 500 of the first embodiment, the rectangular plate-like shaped intervening members 520 are adopted.

In contrast, unlike the first embodiment, a battery module 600 in the second embodiment includes intervening members 620 each including an intervening main body 622 and a plurality of intervening protruding portions 623, and cooling channels 640 for flowing cooling air are formed between each of batteries 100 and each adjacent intervening member 620. The batteries 100 of the second embodiment are different from the batteries 1 of the first embodiment in a range (a region) of the case outer surface 11, where numerous protrusions 11t are formed.

The case outer surface 11 of each of the batteries 100 in the second embodiment includes a plurality of first contact parts 121 (six first contact parts 121 in the present embodiment) and one second contact part 22, which are in contact with corresponding ones of the intervening members 620.

Each of the first contact parts 121 is a portion that contacts with each of a plurality of intervening protruding portions 623 (six intervening protruding portions 623 in the present embodiment) of the intervening member 620, as part of the first wide side surface 14 of the case outer surface 11. Each first contact part 121 includes one first tip abutting part 123 formed with numerous protrusions 11t. Specifically, the entirety of each of the first contact parts 121 corresponds to a first tip abutting part 123. Numerous protrusions 11t formed in each first tip abutting part 123 are identical to the numerous protrusions 11t of the first embodiment. The numerous protrusions 11t of each of the first tip abutting parts 123 abut, at their tips 11tp only, on top faces 623m of each of the intervening protruding portions 623 of the intervening member 620. Thus, the contact area Sta between the first tip abutting part 123 and the intervening member 620 is reduced, i.e., is smaller, than the plane area Soa of the first tip abutting part 123 (Sta<Soa).

The second contact part 22 is identical to the second contact part 22 of the first embodiment and includes the second tip abutting part 24 formed with the numerous protrusions 11t. Consequently, the contact area Stb between the second tip abutting part 24 and the intervening member 620 is reduce, or smaller, than the plane area Sob of the second tip abutting part 24 (Stb<Sob).

In contrast, in the second embodiment, other portions of the case outer surface 11 except for the first contact parts 121 and second contact part 22 are also provided with numerous protrusions 11t. Specifically, the first wide side surface 14 of the case outer surface 11 includes a plurality of spaced facing parts 125 (five spaced facing parts 125 in the present embodiment) facing the intervening main body 622 of the intervening member 620 and being spaced apart from the intervening main body 622, thus forming a plurality of cooling channels 640 (five cooling channels 640 in the present embodiment) between the first wide side surface 14 and the intervening main body 622. The spaced facing parts 125 are also formed with numerous protrusions 11t. The surface area Sh of each spaced facing part 125 is larger than the plane area Soh of a spaced facing part 125 if it were flat without the protrusions 11t (Sh>Soh). This can enhance the heat release property from the spaced facing parts 125 of the first wide side surface 14 of each battery 100 to the cooling channels 640. The surface area Sh of each spaced facing part 125 can be determined by a gaseous adsorption method using Kr gas.

In the second embodiment, as part of the first wide side surface 14 of the case outer surface 11, a surrounding portion around the first contact parts 121 and the spaced facing parts 125, that is, a peripheral edge portion of the first wide side surface 14, is also formed with numerous protrusions 11t. In the second embodiment, in other words, the numerous protrusions 11t are formed over the entire first wide side surface 14.

Further, as part of the second wide side surface 15 of the case outer surface 11, a surrounding portion around the second contact part 22, that is, a peripheral edge portion of the second wide side surface 15, is also formed with numerous protrusions 11t. In the second embodiment, in other words, the numerous protrusions 11t are formed over the entire second wide side surface 15.

Each of the intervening members 620 of the second embodiment includes the rectangular plate-like shaped intervening main body 622 interposed between adjacent ones of the batteries 100, and the plurality of intervening protruding portions 623, each protruding from the intervening main body 622 to the first contact parts 121 of the battery 100 located on the other side EH2 in the arrangement direction EH of the intervening members 620, and contacting with the first contact parts 121. The intervening main body 622 includes a first main surface 622a and a second main surface 622b, each of which has a smaller area than the first wide side surface 14 and the second wide side surface 15 of each battery 100. Each of the intervening members 620 is made of insulating resin as one piece.

Focusing on the relationship between the intervening member 620 and the battery 100 located on the other side EH2 in the arrangement direction EH of the intervening members 620, the plurality of intervening protruding portions 623 is in contact with a plurality of the first contact parts 121 (the first tip abutting parts 123) of the first wide side surface 14 of the case outer surface 11. Specifically, the numerous protrusions 11t provided in the first tip abutting parts 123 abut on the top faces 623m of the intervening protruding portions 623 at their tips 11tp, so that the first contact parts 121 and the intervening protruding portions 623 are in contact with each other over a small area.

The first main surface 622a of the intervening main body 622 faces the spaced facing parts 125 of the first wide side surface 14 of the case outer surface 11 and spaced apart therefrom, thus forming the cooling channels 640 between the first main surface 622a and the spaced facing parts 125.

Focusing on the relationship between the intervening member 620 and the battery 100 located on one side EH1 in the arrangement direction EH of the intervening members 620, the second main surface 622b of the intervening main body 622 contacts with the second contact part 22 (the second tip abutting part 24) of the second wide side surface 15 of the case outer surface 11. Specifically, the numerous protrusions 11t provided in the second tip abutting part 24 abut on the second main surface 622b of the intervening main body 622 at their tips 11tp, so that the second contact part 22 and the second main surface 622b of the intervening main body 622 are in contact with each other over a small area.

In the battery module 600 of the second embodiment, the contact parts 121 and 22 of the case outer surface 11 of each battery 100 respectively include tip abutting parts 123 and 24 whose contact area Sta or Stb with the intervening member 620 is reduced by the numerous protrusions 11t, so that each of the contact parts 121 and 22 of the battery 100 contacts, over a small area, with a corresponding one of the intervening members. This configuration can reduce the heat conduction from the contact parts 121 and 22 of the battery 100 to the intervening members 620 and, even when one of the batteries 100 in the battery module 600 generates heat, this heat is suppressed from transferring to the batteries 100 located adjacent to the one battery 100 via the intervening members 620.

In the second embodiment, furthermore, the cooling channels 640 are formed between the intervening main body 622 of the intervening member 620 and the spaced facing parts 125 of the case outer surface 11 of the battery 100, and the spaced facing parts 125 are each provided with numerous protrusions 11t. The numerous protrusions 11t provided in the spaced facing parts 125 are similar in form to the protrusions 11t of the contact parts 121 and 22 but different in function. That is, the protrusions 11t of the spaced facing parts 125 increase the surface area Sh boarding the cooling channels 640, and thus can efficiently release the heat of the battery 100 through the spaced facing parts 125. In the battery module 600, therefore, the contact parts 121 and 22 as part of the case outer surface 11 can suppress the heat of the battery 100 from transferring to the adjacent batteries 100, that is, can insulate the heat of the battery 100, while allowing the spaced facing parts 125 to efficiently release the heat of the battery 100.

The protrusions 11t of the contact parts 121 and 22 and the protrusions 11t of the spaced facing parts 125 are similar in form. This is advantageous because the numerous protrusions 11t can be formed on the case outer surface 11 at a time by the same method (the metal spraying in the second embodiment).

In addition, identical or similar parts to those of the first embodiment can provide the same operations and effects of the first embodiment.

### Third Embodiment

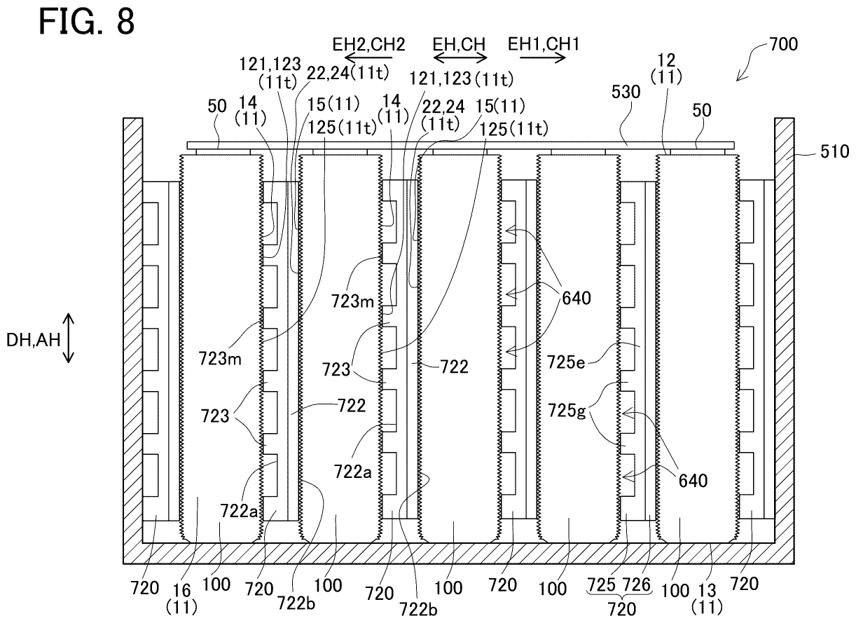

Next, a third embodiment will be described, referring to FIG. 8 and FIG. 7. In this embodiment, similar or identical parts to those of the first or second embodiments are omitted or briefly described. A battery module 700 of the third embodiment includes intervening members 720 each including an intervening main body 722 and intervening protruding portions 723, as with the intervening members 620 of the second embodiment. However, unlike the intervening members 620 of the second embodiment, each intervening member 720 of the third embodiment is composed of two parts, that is, a first intervening member 725 and a second intervening member 726, which are stacked together. In FIG. 7, the boundary between the first intervening member 725 and the second intervening member 726 is indicated by a broken line.

Batteries 100 in the third embodiment are identical to the batteries 100 in the second embodiment. Specifically, the case outer surface 11 of each of the batteries 100 includes the first contact parts 121 and one second contact part 22. Each first contact part 121 includes the first tip abutting part 123 formed with the numerous protrusions 11t and contacts a top face 723m of each of a plurality of intervening protruding portions 723 (six intervening protruding portions 723 in the present embodiment) over a small contact area Sta. Further, each second contact part 22 includes the second tip abutting part 24 formed with the numerous protrusions 11t and contacts a second main surface 722b of the intervening main body 722 of the intervening member 720 over a small contact area Stb. The case outer surface 11 includes the spaced facing parts 125 facing the intervening main body 722 of the intervening member 720 and being spaced apart therefrom, thus forming the cooling channels 640 between the first wide side surface 14 of the case outer surface 11 and the intervening main body 722. The spaced facing parts 125 are also formed with numerous protrusions 11t.

Each of the intervening members 720 in the third embodiment is constituted of the first intervening member 725 and the second intervening member 726.

Each of the first intervening members 725 includes a rectangular plate-like shaped first main body 725e and a plurality of first protruding portions 725g protruding from this first main body 725e to form the intervening protruding portions 723 of the intervening member 720. The first intervening members 725 are made of resin as with the intervening members 620 of the second embodiment.

Each of the second intervening members 726 has a rectangular plate-like shape and is made of rubber as with the intervening members 520 of the first embodiment. The second intervening member 726 and the first main body 725e of the first intervening member 725 are stacked in the arrangement direction EH, forming the intervening main body 722 of the intervening member 720. The intervening main body 722 has a rectangular plate-like shape including a first main surface 722a and the second main surface 722b.

In the battery module 700 of the third embodiment, the contact parts 121 and 22 of the case outer surface 11 of each battery 100 respectively include the tip abutting parts 123 and 24 whose contact areas Sta or Stb with the intervening member 720 is reduced by the numerous protrusions 11t, so that each of the contact parts 121 and 22 of the battery 100 contacts, over a small area, with one of the intervening members 720 located on both sides of the battery 100. This configuration can reduce the heat conduction from the contact parts 121 and 22 of the battery 100 to the intervening members 720 and, even when one battery 100 generates heat, this heat is suppressed from transferring to the batteries 100 located adjacent to the one battery 100 via the intervening members 720. Other parts similar or identical to those in the first or second embodiment can also provide the same operations and advantages as in the first or second embodiment.

The foregoing first to third embodiments are mere examples and give no limitation to the present disclosure. The present disclosure may be embodied in other specific forms without departing from the essential characteristics thereof.

For example, the first to third embodiments respectively exemplify the battery module 500, 600, and 700 in which the batteries 1 or 100 are stacked in a row. However, each of the battery modules may be configured such that a plurality of batteries 1 or 100 are stacked in multiple rows.

In the first to third embodiments, the batteries 1 or 100, forming the battery module 500, 600, or 700 are connected in parallel to each other, but not limited to this connection and may be connected in series to each other.

### REFERENCE SIGNS LIST

1,100 Battery (Power storage device)
10 Case
11 Case outer surface
11t Protrusion
11tp Tip (of Protrusion)
21,121 First contact part
22 Second contact part
23, 123 First tip abutting part
24 Second tip abutting part
125 Spaced facing part
40 Electrode body
500, 600, 700 Battery module (Power storage device module)
510 Module case
520, 620, 720 Intervening member
622, 722 Intervening main body
623, 723 Intervening protruding portion
640 Cooling channel
Sta Contact area (between first tip abutting part and intervening member)
Stb Contact area (between second tip abutting part and intervening member)
Sh Surface area (of spaced facing part)

What is claimed is:

1. A power storage device module comprising:
a plurality of power storage devices arranged in a row; and
an intervening member interposed between adjacent ones of the power storage devices,
each of the power storage devices including an electrode body and a case that is made of metal and houses the electrode body,
the case having a case outer surface exposed to outside,
the case outer surface including a contact part that contacts with the intervening member,
wherein the contact part of the case outer surface includes:
a tip abutting part including numerous protrusions having tips that contact with the intervening member with a smaller contact area than when a tip abutting part is flat without protrusions.

2. The power storage device module according to claim 1, wherein the numerous protrusions are provided on only the contact part of the case outer surface.

3. The power storage device module according to claim 1, wherein
the intervening member includes:
an intervening main body placed between adjacent ones of the power storage devices; and
an intervening protruding portion protruding from the intervening main body to the contact part of at least one of the adjacent power storage devices and contacting the contact part,
the case outer surface of each of the power storage devices includes, in addition to the contact part, a spaced facing part that faces the intervening main body and is spaced apart from the intervening main body, forming a cooling channel between the spaced facing part and the intervening main body, and
the spaced facing part includes the numerous protrusions that provide a larger surface area that borders the cooling channel than when a spaced facing part is flat without the protrusions.
